(19) United States
(12) Patent Application Publication
(10) Pub. No.: US 2005/0169725 A1
(43) Pub. Date: Aug. 4, 2005

(54) Housing comprising a locking device for fixing the same to a carrier plate

(75) Inventors: Marcus Asmuth, Wuppertal (DE); Josef Baerenweiler, Zirndorf (DE); Guenter Fendt, Schrobenhausen (DE); Engelbert Woerle, KUehbach (DE)

Correspondence Address: FASSE PATENT ATTORNEYS, P.A., P.O. BOX 726, HAMPDEN, ME, 04444-0726, US

(73) Assignee: Conti Temic Microelectronic GmbH, Nuernberg (DE)

(21) Appl. No.: 10/513,850

(22) PCT Filed: May 23, 2003
(86) PCT No.: PCT/DE03/01660

(30) Foreign Application Priority Data
May 25, 2002 (DE) 102 23 383.7

(51) Int. Cl. F16B 13/06

(52) U.S. Cl. 411/44

(57) ABSTRACT

The invention relates to a fastening device (23, 60, 30, 70) for the fastening of a housing (20) on a carrier plate (10), whereby the fastening device consists of a fastening means (23, 30) and a means (60, 70) for the expanding or spreading-open of the fastening means, the housing, the carrier plate, and the fastening means respectively comprise an opening (21, 13, 27, 34), the means for the spreading-open is introduced into the opening of the fastening means and remains there, and the fastening means grips behind the carrier plate in the opening thereof, and whereby the introducing of the fastening means and of the means for the spreading-open into the opening of the carrier plate occurs from the same side of the carrier plate, and the turning of the means for the spreading-open effectuates the fixing of the housing in radial and axial direction on the carrier plate.

The invention relates to a fastening device for a housing for the fastening of the housing on a carrier plate according to the preamble of the patent claim 1.

Especially the motor vehicle industry is placing ever greater value on a simple, economical and secure fastening of housings for sensors and control devices. Known screw connections, however, require a threading, which is to be produced with great effort and expense, in the vehicle body, or are not even in the position to introduce into the thin sheet metal of the vehicle body the great fastening forces that are necessary for a secure hold.

From the Publication DE 197 07 421 C2, it is known to fix a thermoplastic housing on a fastening plate, for which the housing comprises engaging catch means, which are a unitary part of the synthetic material housing, and the fastening plate openings for the receiving of the catch means. Such catch means of a thermoplastic synthetic material can, however, represent a mechanical weak location, for which reason they are not suitable, for example, for the fastening of position or motion sensors in vehicles. FROM the Publication DE 197 02 695 C1, engaging catch elements for the rigid connection of two bodies are known, whereby the catch elements comprise a pre-fabricated opening for the reception of a spike or pin. It is disadvantageous that no tensioning or clamping is built up in the axial direction in this connection, and the connection is thus not play-free. Additionally there is the further disadvantage that this connection can only be released with difficulty and with the aid of special tools, which, for example in the exchange of sensors or control devices in a vehicle, necessitates additional expenditure of time and material and thus additional costs. This is even more so, because this connection must be installed from two sides.

The object underlies the invention, to embody or configure a fastening device for a housing for the fastening of the housing on a carrier plate so that a secure, play-free, again-releasable and again-producible connection between housing and carrier plate is realized.

This object is achieved through an arrangement with the characterizing features recited in the claim 1.

The inventive arrangement comprises the advantages that on the one hand a secure fastening and on the other hand a disassembly of the housing can be carried out quickly, and no further parts or an additional tool are necessary. Moreover, the assembly or installation of this fastening can be carried out from one side of the carrier plate.

The invention is especially suitable for the fastening of housings for motion or position sensors and control devices in a vehicle.

Advantageous embodiments of the subject matter of the invention are recited in the dependent claims.

The invention will now be explained on the basis of two example embodiments with the aid of the drawing. It is shown by:

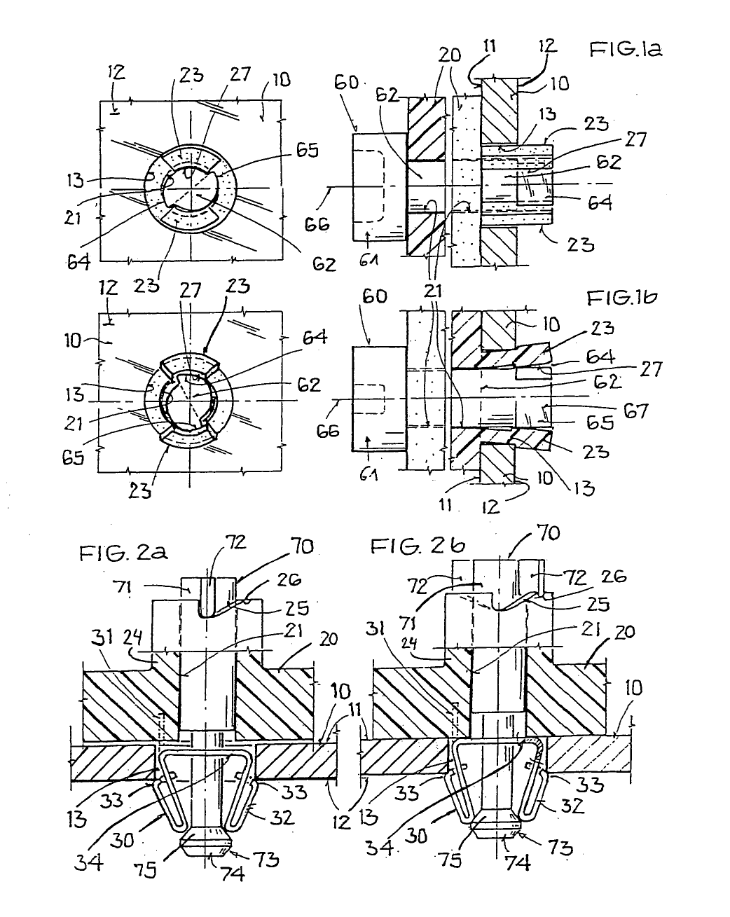

FIG. 1a: a sectional view illustration of a housing with a first inventive integrated catch or latch device and an expanding or spreading eccentric mandrel bolt or pin with loose connection;

FIG. 1b: the housing according to FIG. 1a with tight or fixed connection;

FIG. 2a a perspective view of a second catch device with a stroke-spreading device with loose connection; and

FIG. 2b: the stroke-spreading device according to FIG. 2a with tight or fixed connection.

The FIGS. 1a, b, 2a, b show a carrier plate 10 illustrated in section with a top side 11 and a bottom side 12, on which a housing 20 that is only partially visible and illustrated in section is fastened. The carrier plate 10, which comprises a preferably round or rectangular opening 13 with a center axis, is, for example, a part, consisting of sheet metal or synthetic material, of the vehicle body of a vehicle. The housing 20 comprises an opening 21 with a center axis and consists, for example, of a suitable thermoplastic or thermoset plastic synthetic material and serves for the receiving of a control device, a position or motion sensor. In the finished installed or assembled condition, the openings 13 and 21 are aligned.

In the FIGS. 1a, b, as fastening means, the housing 20 comprises two integrated dowel or stud segments 23 that are preferably simultaneously injected-on or sprayed-on (molded-on) during the fabrication process of the housing 20. The stud segments 23 protrude through the opening 13 of the carrier plate 10. The stud elements 23 are spread-open later during the installation (FIG. 1b), whereby a wedge effect is brought about and thereby it is prevented, that the housing 20 is released from the carrier plate 10.

According to the invention, a mandrel bolt or pin 60, which is not rotationally symmetrical, with a longitudinal or symmetry axis 66 is utilized as means for the spreading open of the stud elements 23. This bolt or pin 60 comprises a head 61 and a shaft 62. In order that the stud segments 23 are spread-open in the radial direction, the shaft 62 must comprise a round cross-section, which is not rotationally symmetrical, along its entire length. Especially from the views from below, of the FIGS. 1a, b, it becomes clear, that the shaft 62 consists of a first half 64 and a second half 65 in a section 67 in the axial direction along the symmetry axis 66, whereby the two halves 64 and 65 are shifted in the radial direction out of the lengthwise or symmetry axis 66 of the shaft 62 and therewith are arranged eccentrically.

For the assembly or installation, which advantageously can take place from only one side, thus for example only from the top side 11, of the housing 20 on the carrier plate 10, first the stud segments 23 are guided through the opening 13, next the bolt or pin 60 is introduced into the opening 21 in the position shown in FIG. 1a, and then the bolt or pin 60 is turned, in the present case in the clockwise direction, into the position shown in FIG. 1b, in which the stud segments 23 spread open, and the housing 20 is securely and play-free fastened on the carrier plate 20 by the wedge effect that is brought about thereby.

Since the radial shifting of the two halves 64 and 65 continuously and uniformly increases in the direction toward the tip of the shaft 62, for example linearly, the eccentricity also increases correspondingly toward the tip of the shaft 62 in the area or region 67. Thereby, during the turning of the bolt or pin 60 in the clockwise direction, as this is especially evident from the two views of the FIG. 1b, the two stud segments 23 are uniformly spread open and prevent the releasing of the housing 20 from the carrier plate 10 due to wedge effect with respect to the opening 13. By turning the bolt or pin 60 back contrary to the clockwise direction, also this connection can be released at any time without problems, perhaps for testing or repair purposes, and thereafter can again be produced.

The FIGS. 2a, b show a perspective view of a second catch device with a stroke-spreading device 70 as means for the spreading-open, which comprise a cylindrical shaft 71, one or two tenons 72 radially formed-on in the proximity of the one end of the shaft 71, and a spreading body 73 applied axially on the other end of the shaft 71. If two tenons 72 are formed onto the shaft 71, these preferably stand opposite one another. The shaft 71 is guided in the opening 21 of the housing 20, whereby a housing wall 24 bounding the opening 21 comprises, per tenon 72, a section 25 rising in the manner of a threading, and a catch location 26 for the tenons 72 adjoining the section 25.

The spreading body 73 consists of a suitable metal, a synthetic material, or some other suitable material and comprises a larger diameter than the shaft 71, a, for example conical, tapering tip 74 for the easier introduction or insertion of the stroke-spreading device 70 into the opening 21, and a component part 75 that conically tapers in the direction of the tenons 72, which effectuates the spreading-open of the U-shaped strips 32.

Instead of the stud segments 23 of the FIGS. 1a, b, in this example embodiment, the housing 20 is fastened play-free on the carrier plate 10 with the aid of a catch means 30 in connection with the stroke-spreading device 70. The catch means 30 with a centrally arranged opening 34 consists of a suitable thermoplastic or thermoset plastic synthetic material or a suitable metal alloy, so that it comprises good spring, form stable, and long time stable characteristics; it is preferably pre-fabricated, and during the production of the housing 20 is laid with one or more anchoring parts 31 into the casting or injection molding form (mold) for the housing 20, and thereby integrated into the housing 20.

At least two, preferably three, four, or more strips 32 bent approximately in a U-shape and extending at an angle to the center axis of the opening 13 or the center axis of the opening 21, adjoin the anchoring parts 31. In turn, an angled-off bracing or supporting part 33 as a further component part of the catch means 30 adjoins each strip 32, whereby the bracing or supporting part 33 in the assembled or installed condition presses against the bottom side 12 of the carrier plate 10 approximately in the form of a collar.

It is, however, also possible, that the catch means 30 comprises no anchoring parts 31 and thus is not integrated into the housing 20. Also in this case the fastening of the housing 20 on the carrier plate 10 can occur one-sided, generally from the top side 11, since the housing 20, the stroke-spreading device 70, and the catch means 30 then form a loose connection.

For the preparation of the fastening of the housing 20 on the carrier plate 10, if the catch means 30 comprises anchoring parts 31 and thereby is integrated into the housing 20, the catch means 30 connected with the housing 20 is pressed into the opening 13 of the carrier plate 10, whereby parts of the catch means 30 reach or grip behind the carrier plate 10 and the angled-off bracing or supporting parts 33 press against the bottom side 12 of the carrier plate 10. For the case that the catch means 30 comprise no anchoring parts 31, first the housing 20, the stroke-spreading device 70 and the catch means 30 are assembled or plugged together to a loose connected assemblage.

For both cases it pertains that, through a subsequently carried out turning of the stroke-spreading device 70 contrary to the clockwise direction, the tenons 72 glide along on the rising section 25 of the housing wall 24, and thereby the conical component part 75 of the spreading body 73 is pressed against the U-shaped strips 32, whereby these are spread open.

The spreading-open of the U-shaped strips 32 effectuates that the bracing or supporting parts 33 are pressed against the bottom side 12 of the carrier plate 10 and thereby the housing 20 is securely fastened on the carrier plate 10. A locking or securing of the fastening is brought about in that the tenons 72 engage or catch into the catch locations 26 and are thus fixed there.

The fastening of the housing 20 on the carrier plate 10 can be released in that first the stroke-spreading device 70 is lifted somewhat in the axial direction (upwardly in the drawing) and turned in the clockwise direction. After the connection is loosened by turning of the stroke-spreading device 70, the housing 20 with the catch means 30 can be removed from the carrier plate 10.

Instead of the catch means 30 shown in the FIGS. 2a, b, the fastening of the housing 20 on the carrier plate 10 can also be carried out in a first variant, through the stud segments 23 shown in the FIGS. 1a, b in combination with the stroke-spreading device 70 of the FIGS. 2a, b. Through a turning of the stroke-spreading device 70 contrary to the clockwise direction, the stud segments 23 are spread open, and the housing 20 is securely and play-free fastened on the carrier plate 10 by the wedge effect that is brought about thereby.

Similarly, in a further variant, instead of the two formed-on stud segments 23 of the FIGS. 1a, b, a catch means 30 integrated into the housing 20, as it is shown in the FIGS. 2a, b, in connection with the mandrel bolt or pin 60, can provide for a secure hold of the housing 20 on the carrier plate 10. Through the turning of the bolt or pin 60 in the clockwise direction, the U-shaped strips 32 are pressed outwardly in the radial direction and the bracing or supporting parts 33 are pressed against the bottom side 12, whereby a secure mechanical connection, which is releasable at any time and again producible, again arises between the carrier plate 10 and the housing 20. The assembly or installation in both variants can advantageously occur from one side of the carrier plate 10.

A different advantageous embodiment of the example embodiment according to the FIGS. 2a, b consists in applying or disposing a device known from the German Patent De 199 01 357 C1 on the end of the shaft 71 of the stroke-spreading device 70 lying opposite the spreading body 73, with which known device the loosening or releasing of the fastening of the housing 20 on the carrier plate 10 shown in the FIGS. 2a, b is prevented, as long as a plug, for example for the electrical supply, is still plugged into a plug shaft or recess (not shown) of the housing 10.

1. Fastening device (23, 60; 30, 70) for a housing (20) for the fastening of the housing (20) on a carrier plate (10), whereby
a) the fastening device (23, 60; 30, 70) consists of a fastening means (23; 30) and a means for the spreading-open (60, 70) of the fastening means (23; 30),
b) the housing (20), the carrier plate (10) and the fastening means (23; 30) respectively comprise an opening (21, 13, 27; 34),
c) the means for the spreading-open (60, 70) is introduced into the opening (27; 34) of the fastening means (23; 30) and remains there, and
d) the fastening means (23; 30) grips behind the carrier plate (10) in the opening (13) thereof,
characterized in that
e) the introducing of the fastening means (23; 30) and of the means for the spreading-open (60; 70) into the opening (13) of the carrier plate (10) occurs from the same side of the carrier plate (10), and
f) the turning of the means for the spreading-open (60; 70) effectuates the fixing of the housing (20) in the radial and axial direction on the carrier plate (10).

2. Fastening device (23, 60; 30, 70) according to claim 1, characterized in that the fastening means (23; 30) involves a separate part.

3. Fastening device (23, 60; 30, 70) according to claim 1, characterized in that the fastening means (23; 30) involves a part of the housing (20).

3-13. (canceled)

14. Fastening device (23, 60; 30, 70) according to claim 1, characterized in that the fastening means (23; 30) is produced of a material deviating from the housing (20).

15. Fastening device (23, 60; 30, 70) according to claim 14, characterized in that the housing (20) is a synthetic material housing and the fastening means (23; 30) is a metallic insert part.

16. Fastening device (23, 60; 30, 70) according to claim 1, characterized in that the fastening means (23; 30) is produced of the same material as the housing (20).

17. Fastening device (23, 60; 30, 70) according to claim 1, characterized in that the means for the spreading-open (60; 70) is embodied thread-less.

18. Fastening device (23, 60; 30, 70) according to claim 1, characterized in that the means for the spreading-open (60, 70) comprises a pin (60) that is not rotationally-symmetrical.

19. Fastening device (23, 60; 30, 70) according to claim 1, characterized in that the means for the spreading-open (60; 70) comprises a stroke-spreading device (70).

20. Fastening device (23, 60; 30, 70) according to claim 19, characterized in that the stroke-spreading device (70) comprises a cylindrical shaft (71), one or two tenons (72) formed-on radially in the proximity of the one end of the shaft (71), and a spreading body (73) applied axially on the other end of the shaft (71), and a housing wall (24) bounding the housing opening (21) comprises, per tenon (72), a threading-like rising section (25) and a catch location (26) adjoining the section (25).

21. Fastening device (23, 60; 30, 70) according to claim 1, characterized in that the fastening means (23; 30) comprises stud segments (23).

22. Fastening device (23, 60, 30, 70) according to claim 1, characterized in that the fastening means (23; 30) comprises catch means (30).

23. Fastening device (23, 60; 30, 70) according to claim 22, characterized in that the catch means (30) comprises at least two strips (32) bent approximately U-shaped and extending at an angle to the center axis of the housing opening (21), whereby an angled-off bracing part (33) adjoins each strip (32).
